(19) United States
(12) Patent Application Publication
(10) Pub. No.: US 2009/0283157 A1
(43) Pub. Date: Nov. 19, 2009

(54) Check Valve Assembly

(75) Inventor: Terrence D. Hogan, Saline, MI (US)

Correspondence Address: Quinn Law Group, PLLC, 39555 Orchard Hill Place, Suite 520, Novi, MI, 48375, US

(73) Assignee: GM GLOBAL TECHNOLOGY OPERATIONS, INC., Detroit, MI (US)

(21) Appl. No.: 12/199,101

(22) Filed: Aug. 27, 2008

Related U.S. Application Data
(60) Provisional application No. 61/053,864, filed on May 16, 2008.

(51) Int. Cl. F16K 15/06

(52) U.S. Cl. 137/542

(57) ABSTRACT

A check valve assembly is provided for regulating the flow of pressurized fluid in a hydraulic circuit. The check valve assembly includes a valve housing defining a valve chamber with first and second spaced openings. A poppet is slidably arranged inside the valve chamber to transition between a seated position, in which the poppet fluidly seals one of the openings, and an unseated position, in which the poppet fluidly unseals the opening. A plurality of fins protrudes outward from one end of the poppet to engage with the inner surface of the valve chamber. A disk, which is oriented inside the valve chamber, defines a receiving slot that is configured to receive and mate with a second end of the poppet. The disk and fins cooperate to maintain the poppet in coaxial alignment with the longitudinal center axis of the valve chamber during transitions between the seated and unseated positions.

### CLAIM OF PRIORITY AND CROSS-REFERENCE TO RELATED APPLICATION

This application claims the benefit of and priority to U.S. Provisional Patent Application No. 61/053,864, filed on May 16, 2008, which is hereby incorporated by reference in its entirety.

### TECHNICAL FIELD

The present invention relates generally to hydraulic flow control devices, and more particularly to poppet-type check valve assemblies for regulating the flow of pressurized fluid through a hydraulic control unit.

### BACKGROUND OF THE INVENTION

Conventional motorized vehicles, such as the modern day automobile, include a powertrain that is comprised of an internal combustion engine (ICE) in power flow communication with a final drive system (e.g., rear differential and wheels) via a multi-speed power transmission. Hybrid type powertrains generally employ an ICE and one or more motor/generator units that operate individually or in concert to propel the vehicle. That is, power output from the engine and motor/generators are transferred through planetary gearing in the multi-speed transmission to be transmitted to the vehicle's final drive. The primary function of the multi-speed power transmission is to regulate speed and torque to meet operator demands for vehicle speed and acceleration.

Most automatic transmissions include a number of gear elements, such as epicyclic planetary gear sets, for coupling the transmission's input and output shafts. One or more hydraulically actuated torque establishing devices, such as clutches and brakes (the term “torque transmitting device” often used to refer to both clutches and brakes) are selectively engageable to activate the above mentioned gear elements for establishing desired forward and reverse speed ratios between the input and output shafts. Engine torque and speed are converted by the transmission, for example, in response to the tractive-power demand of the motor vehicle.

Shifting from one forward speed ratio to another is performed in response to engine throttle and vehicle speed, and generally involves releasing one or more “off-going” clutches associated with the current or attained speed ratio, and applying one or more “on-coming” clutches associated with the desired or commanded speed ratio. To perform a “downshift”, a shift is made from a low speed ratio to a high speed ratio. That is, the downshift is accomplished by disengaging a clutch associated with the lower speed ratio, and engaging a clutch associated with the higher speed ratio, to thereby reconfigure the gear set(s) to operate at the higher speed ratio. Shifts performed in the above manner are termed clutch-to-clutch shifts, and require precise timing in order to achieve high quality shifting.

To engage clutches properly, most power transmissions require a supply of pressurized fluid, such as conventional transmission oil. The pressurized fluid may also be used for such functions as cooling and lubrication. The lubricating and cooling capabilities of transmission oil systems greatly impact the reliability and durability of the transmission. Additionally, multi-speed power transmissions require pressurized fluid for controlled engagement and disengagement, on a desired schedule, of the various torque transmitting mechanisms that operate to establish the speed ratios within the internal gear arrangement.

The various hydraulic subsystems of an automatic transmission, such as the abovementioned torque transmitting devices, are typically controlled through operation of a hydraulic circuit, often referred to as a hydraulic valve system or hydraulic control module. The hydraulic control module traditionally engages (actuates) or disengages (deactivates) the various transmission subsystems through the manipulation of hydraulic pressure generated by one or more oil pump assemblies. The valves used in a conventional hydraulic control circuit commonly comprise, for example, electro-hydraulic devices (e.g., solenoids), spring-biased accumulators, spring-biased spool valves, ball check valves, and poppet check valves.

Check valve assemblies, such as ball- and poppet-type check valves, are often designed to permit fluid to flow in one direction, and restrict fluid flow in the opposite direction. Check valves are characterized by a movable fluid control element (e.g., the poppet or check ball) that is used to close (seal) and open (unseal) one or more valve ports. A biasing member, such as a compression spring, operates to urge the fluid control element off its seat allowing a flow path (e.g., in the case of a 2-way, normally open valve), or closing off a flow path by pushing the fluid control element onto a seat (e.g., in the case of a 2-way normally closed valve). In regard to the latter, the spring acts to bias the fluid control element against the valve seat until the upstream fluid pressure acting against the fluid control element exceeds the spring force of the biasing member, unseating the fluid control element to allow fluid flow above a predetermined fluid pressure.

### SUMMARY OF THE INVENTION

According to one embodiment of the present invention, a check valve assembly for regulating the flow of pressurized fluid in a hydraulic circuit is provided. The check valve assembly includes a valve housing that defines a valve chamber therethrough. The valve chamber has first and second spaced openings, and a longitudinal center axis. The check valve assembly also includes a fluid control element arranged substantially inside the valve chamber to transition between a seated position, in which the fluid control element fluidly seals one of the valve chamber openings, and an unseated position, in which the fluid control element allows fluid to pass through the now unsealed opening. The check valve also includes first and second guide elements respectively disposed at opposing ends thereof. The guide elements cooperate to maintain the fluid control element in coaxial alignment with the longitudinal center axis of the valve chamber during transitions between the seated and unseated positions.

According to one aspect of this embodiment, the first guide element includes a plurality of fin members that extend between and engage the fluid control element and the inner surface of the valve chamber to thereby radially align a first end of the fluid control element with the longitudinal center axis of the valve chamber. Ideally, the valve chamber includes an inlet portion connected to an outlet portion by a seat portion. In this instance, each of the fin members has a forward edge with a first angle relative to the longitudinal center axis of the valve chamber, whereas the seat portion has a second angle relative to the longitudinal center axis that is greater than the first angle.

In accordance with another aspect of this embodiment, the second guide element includes a disk member with a receiving slot that is configured to receive and thereby radially align a second end of the fluid control element with the longitudinal center axis of the valve chamber. It is also desired that the fluid control element includes a stop oriented between first and second ends thereof. The stop is configured to bottom out against the disk member at a predetermined forward fluid flow rate. In addition, the disk member preferably defines a plurality of apertures therethrough that are collectively configured to allow a predetermined cross-sectional area of fluid flow to pass therethrough.

According to yet another aspect of this embodiment, the check valve assembly also includes an elastomeric ring that is attached to either the valve housing or the fluid control element. The elastomeric ring is configured to engage the other of the valve housing and fluid control element when the fluid control element is in the seated position. Ideally, the fluid control element is configured to bottom out against the valve housing at a predetermined reverse pressure and thereby reduce pressure on the elastomeric ring when the fluid control element is in the seated position. In addition, the fluid control element preferably includes a conical portion that extends from one end thereof. The conical portion is connected to a landing portion by a reduced diameter stepped region. In this instance, the elastomeric ring extends continuously about the stepped region.

As part of yet another aspect of this particular embodiment, a biasing member is in operative communication with the fluid control element, and configured to bias the same into either the seated or unseated positions.

In accordance with another embodiment of this invention, a check valve assembly is provided for regulating the flow of pressurized fluid through a hydraulic control circuit. The check valve assembly includes a valve housing with a valve chamber having first and second openings spaced apart along a longitudinal center axis thereof. The check valve assembly also includes a fluid control element having a stem portion with a fluid obstruction element at a first end thereof. The fluid control element is slidably arranged substantially inside the valve chamber to transition between a seated position, in which the fluid obstruction element is positioned against the valve housing to fluidly seal the first opening, and an unseated position, in which the fluid obstruction element is distanced from the valve housing to thereby allow fluid to pass through the first opening.

A plurality of fin members protrudes outward from the first end of the fluid control element, and engage with the inner surface of the valve chamber. A disk member is oriented inside the valve chamber, and defines a receiving slot therethrough that is configured to receive and mate with a second end of the stem portion. The disk member and fin members cooperate to keep the poppet in coaxial alignment with the longitudinal center axis of the valve chamber during transitions between the seated and unseated positions.

According to one aspect of this particular embodiment, the fluid obstruction element includes a substantially cylindrical landing portion with three of the fin members circumferentially spaced equidistant from one another around an outer peripheral surface of the landing portion.

In another aspect, the valve chamber includes substantially cylindrical inlet and outlet portions that are connected by an angled seat portion that extends therebetween. The inlet portion has a first diameter, whereas the outlet portion has a second diameter that is greater than the first diameter. In this particular instance, each of the fin members has a forward edge that is proximal to the seat portion. The forward edge of the fin members have a first angle relative to the longitudinal center axis of the valve chamber, whereas the seat portion has a second angle relative to the longitudinal center axis that is greater than the first angle. Preferably, the fluid control element is configured such that the forward edge of each fin member bottoms out against the seat portion of the valve chamber at a predetermined reverse pressure.

In accordance with a different aspect of this embodiment, the stem portion includes a stepped, stop portion that is oriented between first and second ends thereof. The stop portion is configured to bottom out against the disk member at a predetermined forward fluid flow rate.

According to another aspect, the fluid obstruction element includes a conical portion extending from the first end thereof. The conical portion is connected to a landing portion by a reduced diameter stepped region. The fluid obstruction element also includes an elastomeric ring that extends continuously about the stepped region, between the conical and landing portions. The elastomeric ring is configured to engage the valve housing to thereby effect the fluid seal between the fluid obstruction elements and the valve housing when the fluid control element is in the seated position.

In yet another aspect, the check valve assembly also includes a retainer ring configured to press fit into the second opening of the valve chamber. The retainer ring is adapted to mate with and thereby retain the disk member inside the valve chamber.

According to yet another embodiment of the present invention, a poppet-type check valve assembly for regulating the flow of pressurized fluid in a hydraulic control circuit is described. The poppet check valve assembly includes a valve housing that defines a generally cylindrical valve chamber therethrough. The valve chamber has opposing inlet and outlet ports that are coaxially arranged and distanced from each other along a longitudinal center axis of the valve chamber.

The poppet check valve assembly also includes a poppet having a stem portion with a fluid obstruction element positioned at a first end thereof. The poppet is slidably arranged inside the valve chamber to transition linearly along the center axis of the valve chamber between a seated position, in which the fluid obstruction element is pressed against a seat portion of the valve housing to fluidly seal the inlet port, and an unseated position, in which the obstruction element is distanced from the seat portion thereby allowing fluid to pass from the inlet port to the outlet port. A spring member is in operative communication with the poppet to bias the same into the seated position.

The obstruction element includes a plurality of circumferentially oriented fin members protruding outward therefrom to engage with the inner surface of the valve chamber. A disk member that defines a receiving slot configured to receive and mate with a second end of the stem portion is oriented inside of the valve chamber. The disk member and the plurality of fin members cooperate to maintain the poppet in coaxial (e.g., radial) alignment with the longitudinal center axis of the valve chamber during the transition between the seated and unseated positions.

The above features and advantages, and other features and advantages of the present invention will be readily apparent from the following detailed description of the preferred embodiments and best modes for carrying out the invention when taken in connection with the accompanying drawings and appended claims.

### BRIEF DESCRIPTION OF THE DRAWINGS

FIG. 1 is a schematic representation of an exemplary vehicle powertrain arrangement for incorporation and use of the present invention;

FIG. 2 is an exploded perspective-view illustration of a poppet check valve assembly in accordance with the present invention; and

FIG. 3 is a side-view illustration in partial cross-section of the assembled poppet check valve assembly of FIG. 2.

### DESCRIPTION OF THE PREFERRED EMBODIMENTS

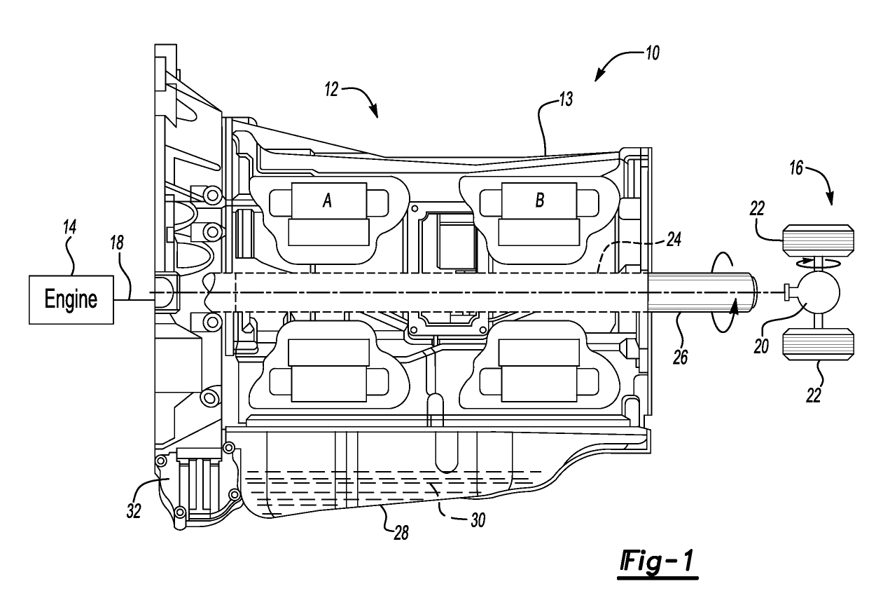

The present invention is described herein in the context of a motor vehicle powertrain having a multi-speed hybrid-type power transmission, as seen in FIG. 1. The hybrid powertrain illustrated in FIG. 1 has been greatly simplified, it being understood that further information regarding the standard operation of a hybrid power transmission (or a hybrid-type vehicle for that matter) may be found in the prior art. Furthermore, it should be readily understood that FIG. 1 merely offers a representative application by which the present invention may be incorporated and practiced. As such, the present invention is by no means limited to the particular arrangement illustrated in FIG. 1. Finally, the drawings provided herein are not to scale, and are provided purely for clarification purposes. Thus, the individual and relative dimensions of the drawings presented herein are not to be considered limiting.

Referring to the drawings, wherein like reference numbers refer to like components throughout the several views, there is shown in FIG. 1 a schematic depiction of an exemplary vehicle powertrain system, identified generally as 10, having a restartable engine 14 that is selectively drivingly connectable to, or in power flow communication with, a final drive system 16 via a hybrid-type power transmission 12. The engine 14 transfers power, preferably by way of torque, to the transmission 12 via an engine output shaft 18 (more commonly referred to as a “crankshaft”). The transmission 12, in turn, distributes torque from a transmission output shaft 26 to drive the final drive system 16, represented herein by a rear differential 20 and wheels 22, and thereby propel the hybrid vehicle (not specifically identified). In the embodiment depicted in FIG. 1, the engine 14 may be any engine, such as, but not limited to, a 2-stroke diesel engine or a 4-stroke gasoline engine, which is readily adapted to provide its available power output typically at a number of revolutions per minute (RPM). Although not specifically illustrated in FIG. 1, it should be appreciated that the final drive system 16 may comprise any known configuration, such as front wheel drive (FWD), rear wheel drive (RWD), four-wheel drive (4WD), or all-wheel drive (AWD).

The transmission 12 is adapted to manipulate and distribute power from the engine 14 to the final drive system 16. Specifically, engagement of one or more torque transmitting devices (e.g., hydraulically actuated brakes or clutches) included in the transmission 12 interconnects one or more differential epicyclic gear arrangements, preferably in the nature of interconnected planetary gear sets (none of which are visible in FIG. 1) to transfer power from the engine 14 at varying ratios to the transmission output shaft 26. The transmission 12 may utilize one or more planetary gear sets in collaboration with, or independent of, one or more clutches or brakes to provide input split, compound split, and fixed ratio modes of operation.

FIG. 1 displays certain selected components of the transmission 12, including a main housing 13 configured to encase and protect first and second electric motor/generator assemblies A and B, respectively. The first and second motor/generators A, B are indirectly joumaled onto a main shaft of the transmission 12, shown hidden at 24, preferably through the above noted series of planetary gear sets. The first and second motor/generators A, B operate, in conjunction with the planetary gear sets and selectively engageable torque transmitting mechanisms, to rotate the transmission output shaft 26. The main housing 13 covers the inner most components of the transmission 12, such as the motor/generators A, B, planetary gear arrangements, main shaft 24, and torque transmitting devices. The motor/generator assemblies A, B are preferably configured to selectively operate as a motor and a generator. That is, the motor/generator assemblies A, B are capable of converting electrical energy to mechanical energy (e.g., during vehicle propulsion), and converting mechanical energy to electrical energy (e.g., during regenerative braking).

An oil pan or sump volume 28 (also referred to herein as “hydraulic fluid reservoir”) is located on the base of the main housing 13, and is configured to stow or store hydraulic fluid, such as transmission oil (shown hidden in FIG. 1 at 30) for the transmission 12 and its various components. Additionally, an auxiliary (or secondary) transmission pump 32 is mounted to the main transmission housing 13, nested adjacent to the oil pan 28 and in fluid communication therewith. It should be recognized, however, that the auxiliary oil pump 32 may be located at numerous other locations relative to the transmission housing 13 (e.g., above the fluid level of transmission oil 30) without departing from the intended scope of the present invention. The auxiliary oil pump 32 is in fluid communication (e.g., via hydraulic circuitry) with the transmission 12 to provide pressurized fluid to the transmission 12 during specific operating conditions, such as engine-off mode and transitionary phases thereto and therefrom.

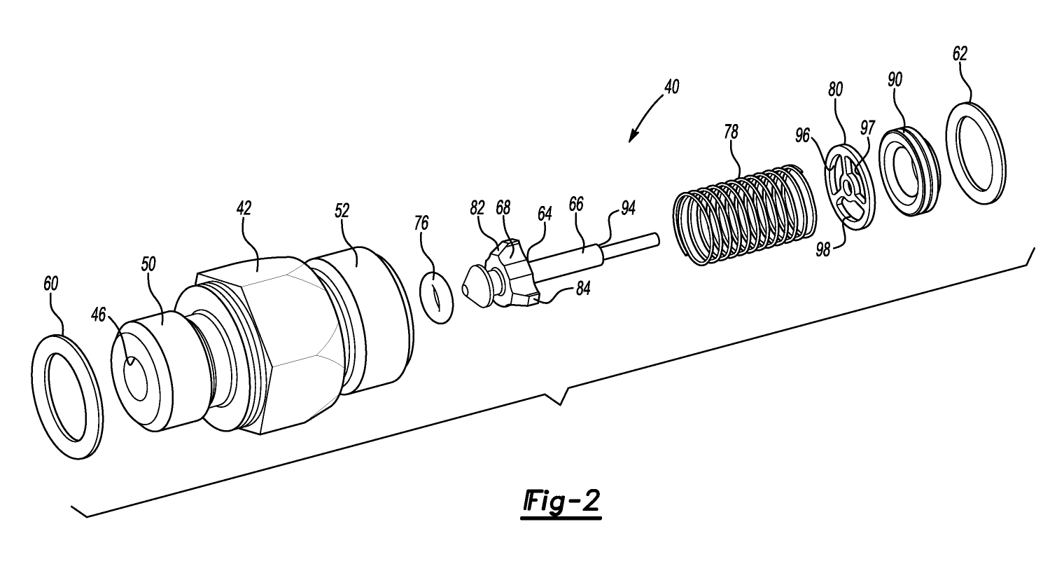

An exploded perspective-view illustration of a poppet-type check valve assembly in accordance with a preferred embodiment of the present invention is shown generally at 40 in FIG. 2. The poppet check valve assembly 40, which may also be referred to herein as “check valve” or “valve assembly”, is depicted as a soft-seat, 2-way, normally-closed type valve assembly, intended to regulate the unidirectional flow of pressurized fluid in an electro-hydraulic control system of a hybrid powertrain, such as powertrain 10 of FIG. 1. It should be readily recognized, however, that the principle novelties of the present invention may be incorporated into other applications within the scope of the appended claims. By way of example, and not limitation, the present invention may be incorporated into hard- or soft-seat, multi-directional poppet valve assemblies, which may be of the normally-closed or normally-open type.

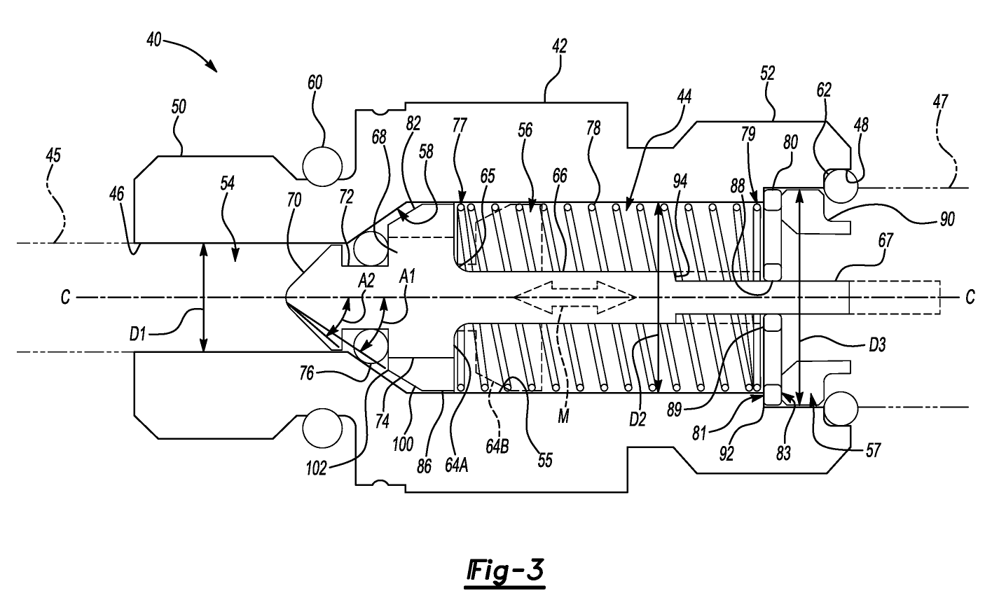

Looking at both FIGS. 2 and 3, the check valve 40 includes a valve body or housing 42 that defines a substantially cylindrical valve chamber, generally indicated at 44 in FIG. 3, which extends therethrough. The valve chamber 44 has a first opening 46 (which is preferably a fluid inlet port) in opposing relation to a second opening 48 (most desirably a fluid outlet port) that are coaxially arranged and spaced from each other along a longitudinal center axis C of the valve chamber 44. The inlet port 46 is oriented as shown in FIG. 3 for transmitting pressurized control medium (e.g., hydraulic fluid 30 of FIG. 1) received from a first hydraulic circuit, shown schematically in FIG. 3 with phantom lines 45, through valve chamber 44 and outlet port 48, to a second hydraulic circuit, shown schematically in FIG. 3 with phantom lines 47.

The first and second outer free ends 50 and 52, respectively, of the valve body 42 are provided with suitable connecting means, such as compression couplings or helical threads (not shown), which allow the valve assembly 40 to be coupled to fluid inlet and outlet lines (not shown). First and second elastomeric o-rings 60 and 62, respectively, are operatively oriented along and mated with the valve body 42, relative to the first and second free ends 50, 52, to provide a fluid-tight seal between the check valve assembly 40 and the fluid inlet and outlet lines.

The valve chamber 44 may be divided into three primary portions—a substantially cylindrical inlet portion 54 that is connected to a substantially cylindrical outlet portion 56 by an angled, annular seat portion 58. The inlet portion 54 has a first diameter D1, and the outlet portion 56 has a second diameter D2 that is greater than the inlet portion diameter D1. A cylindrical end portion 57 is formed downstream of the outlet portion 56. The end portion 57 has a third diameter D3 that is greater than both the first and second diameters D1, D2. It should be recognized that the geometric configurations of the individual portions of the valve chamber 44 may be individually or collectively modified without departing from the intended scope of the present invention.

The poppet check valve assembly 40 also includes a fluid control element, such as poppet 64, which has a stem portion 66 with a fluid obstruction element 68 protruding from a first end 65 thereof. The obstruction element 68, as depicted in FIGS. 2 and 3, includes a conical end portion 70 connected to a generally cylindrical landing portion 74 by a substantially cylindrical stepped region 72. An elastomeric ring member (or third o-ring) 76 extends continuously about the stepped region 72, trapped between the conical and landing portions 70, 74 of the obstruction element 68. Alternatively, the elastomeric ring member 76 may be integrally molded to the poppet 64, or may be attached to or formed in the valve housing 42. As will be explained in extensive detail hereinbelow, the obstruction element 68 is configured to fluidly seal one of the openings 46, 48 in the valve body 42 to restrict the flow of hydraulic fluid through the valve chamber 44.

The poppet 64 is operatively arranged inside the valve chamber 44 to translate back-and-forth along the center axis C, such movement represented in FIG. 3 by hidden arrow M. Specifically, the poppet 64 transitions along a substantially linear path of displacement between a seated position (indicated by reference numeral 64A in FIG. 3), in which the obstruction element 68 is positioned or pressed against the valve housing 42 to fluidly seal the inlet port 46 (i.e., restrict the flow of hydraulic fluid therethrough), and an unseated position (represented by a hidden poppet 64B in FIG. 3), in which the obstruction element 68 is distanced from the valve body 42, namely seat portion 58, to allow fluid to pass through the valve chamber 44 from the inlet port 46 to the outlet port 48.

A biasing member, such as a coil spring 78, is in operative communication with the poppet 64, and configured to bias the same into the seated position 64A. That is, a first end 77 of the coil spring 78 presses against a plurality of integrally formed fin members that protrude outward from the landing portion 74 of the poppet 64, as seen in FIG. 3. A second end 79 of the coil spring 78 presses against an inner surface 81 of a guide element 80 that is mechanically coupled to the end portion 57 of the valve chamber 44. The compressive force of the coil spring 78 presses the conical end portion 70 of the obstruction element 68 into the inlet portion 54, and forces the elastomeric ring member 76 against the valve body 42, compressing the elastomeric ring member 76 between the seat portion 58 and obstruction element 68, creating a fluid seal therebetween. The coil spring 78 acts to bias the poppet 64 against the valve seat 58 until the upstream fluid pressure acting against the poppet 64 exceeds the spring force of the coil spring 78, unseating the poppet 64 to allow fluid flow above a predetermined fluid pressure.

In accordance with the present invention, the check valve assembly 40 includes first and second guide elements that are engineered to maintain the poppet 64 in coaxial alignment (e.g., radially aligned) with the longitudinal center axis C during the transition between the seated and unseated positions 64A, 64B. Specifically, as noted above, the obstruction element 68 includes a plurality of fin members, namely first, second and third fin members 82, 84 and 86, respectively (82 and 84 visible in FIG. 2, 82 and 86 visible in FIG. 3). The fin members 82, 84, 86 are circumferentially oriented equidistant from one another around an outer peripheral surface of the landing portion 74. Each fin 82, 84, 86 protrudes outward from the landing portion 74 to engage with an inner surface 55 of the valve chamber 44.

As noted above, a second guide element 80 (also referred to herein as “disk member”) with a receiving slot 88 (FIG. 3) formed therethrough is mechanically coupled to the valve body 42, in the end portion 57 thereof. Specifically, a retainer ring 90 is designed to press fit into the second opening 48 of the valve chamber 44. The retainer ring 90 abuts or presses against an outer surface 83 of the disk member 80, and thereby traps the disk member 80 between a shoulder portion 92 of the valve chamber 44 and the retainer ring 90. The receiving slot 88 is configured to receive and mate with a second end 67 of the poppet stem portion 66. In so doing, the disk member 80, which aligns the poppet stem portion 66 with the center axis C, and the plurality of fin members—i.e., first, second, and third fin members 82, 84, 86, which align the poppet obstruction element 68 with the center axis C, cooperate to maintain the poppet 64 in radial alignment with the longitudinal center axis C of the valve chamber 44 during transitions between the seated and unseated positions 64A, 64B.

With continuing reference to FIG. 3, the stem portion 66 includes a stop or step portion 94 that is oriented between the first and second ends 65, 67 thereof. The stop 94 is designed and oriented to bottom out against a contact perimeter 89 of the disk member 80, which surrounds the receiving slot 88, at a predetermined forward fluid flow rate. By orienting the stop 94 at a predefined location, the poppet 64 is designed to prevent inadvertent pressure fluctuations (e.g., resonant oscillations) downstream of the check valve assembly 40 above the predetermined fluid flow rate.

The disk member 80 includes a plurality of fluid apertures, such as first, second and third apertures 96, 97 and 98, respectively (best seen in FIG. 2). The size (i.e., cross-sectional area) and geometry of the apertures 96, 97, 98 are specifically designed to allow a predetermined cross-sectional area of fluid flow to pass therethrough.

The poppet 64 is also configured such that the fin members 82, 84, 86 bottom out with metal-to-metal contact against the seat portion 58 at a predetermined reverse pressure to prevent damage to the elastomeric ring member 76. That is, each of the fin members 82, 84, 86 has a forward edge (represented collectively in FIG. 3 at 100) with a first angle A1 relative to the longitudinal center axis C of the valve chamber. The seat portion 58, on the other hand, has a second angle A2 relative to the center axis C that is greater than the first angle A1. When the elastomeric ring 76 compresses under the predetermined reverse pressure, a front-most portion 102 of the forward edge 100 will contact and ground-out against the seat portion 58. In so doing, potential damage to the ring member 76 resulting from high reverse fluid pressures is prevented.

While the best modes for carrying out the present invention have been described in detail herein, those familiar with the art to which this invention pertains will recognize various alternative designs and embodiments for practicing the invention within the scope of the appended claims.

1. A check valve assembly for regulating the flow of pressurized fluid in a hydraulic circuit, the check valve assembly comprising:
a valve housing defining a valve chamber therethrough with first and second spaced openings, said valve chamber having a longitudinal center axis;
a fluid control element operatively arranged substantially inside said valve chamber to transition between a seated position, in which said fluid control element fluidly seals one of said first and second openings, and an unseated position, in which said fluid control element fluidly unseals said one of said first and second openings; and
first and second guide elements respectively disposed at opposing ends of said fluid control element, wherein said first and second guide elements cooperate to maintain said fluid control element in coaxial alignment with said longitudinal center axis during transitions between said seated and unseated positions.

2. The check valve assembly of claim 1, wherein said first guide element includes a plurality of fin members extending between and engaging said fluid control element and an inner surface of said valve chamber to thereby radially align a first end of said fluid control element with said longitudinal center axis.

3. The check valve assembly of claim 2, wherein said valve chamber includes an inlet portion connected to an outlet portion by a seat portion, and wherein each of said plurality of fin members has a forward edge with a first angle relative to said longitudinal center axis and said seat portion has a second angle relative to said longitudinal center axis that is greater than said first angle.

4. The check valve assembly of claim 1, wherein said second guide element includes a disk member defining a receiving slot configured to receive and thereby radially align a second end of said fluid control element with said longitudinal center axis.

5. The check valve assembly of claim 4, wherein said fluid control element includes a stop oriented between first and second ends thereof and configured to bottom out against said disk member at a predetermined forward fluid flow rate.

6. The check valve assembly of claim 4, wherein said disk member defines a plurality of apertures therethrough collectively configured to allow a predetermined cross-sectional area of fluid flow to pass therethrough.

7. The check valve assembly of claim 1, further comprising:
an elastomeric ring operatively attached to one of said valve housing and said fluid control element and configured to engage the other of said valve housing and said fluid control element when said fluid control element is in said seated position.

8. The check valve assembly of claim 7, wherein said fluid control element is configured to bottom out against said valve housing at a predetermined reverse pressure and thereby reduce pressure on said elastomeric ring when said fluid control element is in said seated position.

9. The check valve assembly of claim 7, wherein said fluid control element includes a conical portion extending from one end thereof and connected to a landing portion by a reduced diameter stepped region, wherein said elastomeric ring extends continuously about said stepped region.

10. The check valve assembly of claim 1, further comprising:
a biasing member in operative communication with said fluid control element and configured to bias the same into one of said seated and unseated positions.

11. A check valve assembly for regulating the flow of pressurized fluid through a hydraulic control circuit, the check valve assembly comprising:
a valve housing defining a valve chamber therethrough with first and second openings spaced apart along a longitudinal center axis of said valve chamber;
a fluid control element having a stem portion with a fluid obstruction element at a first end thereof, said fluid control element slidably arranged substantially inside said valve chamber to transition between a seated position, in which said fluid obstruction element is positioned against said valve housing to fluidly seal said first opening, and an unseated position, in which said fluid obstruction element is distanced from said valve housing to thereby allow fluid to pass through said first opening;
a plurality of fin members protruding outward from said first end of said fluid control element and configured to engage with an inner surface of said valve chamber; and
a disk member oriented inside said valve chamber and defining a receiving slot therethrough configured to receive and mate with a second end of said stem portion;
wherein said disk member and said plurality of fin members cooperate to maintain said poppet in coaxial alignment with said longitudinal center axis of said valve chamber during transitions between said seated and unseated positions.

12. The check valve assembly of claim 11, wherein said fluid obstruction element includes a substantially cylindrical landing portion, and wherein said plurality of fin members includes three fin members circumferentially spaced equidistant from one another around an outer peripheral surface of said landing portion.

13. The check valve assembly of claim 11, wherein said valve chamber includes substantially cylindrical inlet and outlet portions connected by an angled seat portion extending therebetween, said inlet portion having a first diameter and said outlet portion having a second diameter greater than said first diameter.

14. The check valve assembly of claim 13, wherein each of said plurality of fin members has a forward edge proximal to said seat portion with a first angle relative to said longitudinal center axis of said valve chamber, and wherein said seat portion has a second angle relative to said longitudinal center axis that is greater than said first angle.

15. The check valve assembly of claim 14, wherein said fluid control element is configured such that said forward edge of each fin member bottoms out against said seat portion at a predetermined reverse pressure.

16. The check valve assembly of claim 11, wherein said stem portion includes a stepped stop portion oriented between said first and second ends thereof and configured to bottom out against said disk member at a predetermined forward fluid flow rate.

17. The check valve assembly of claim 11, wherein said fluid obstruction element includes a conical portion extending from said first end thereof and connected to a landing portion by a reduced diameter stepped region, and an elastomeric ring extending continuously about said stepped region and configured to engage said valve housing to effect said fluid seal when said fluid control element is in said seated position.

18. The check valve assembly of claim 11, further comprising:
a retainer ring configured to press fit into said second opening of said valve chamber, and mate with and thereby retain said disk member inside said valve chamber.

19. The check valve assembly of claim 11, further comprising:
a biasing member in operative communication with said fluid control element and configured to bias the same into said seated position.

20. A poppet check valve assembly for regulating the flow of pressurized fluid in a hydraulic control circuit, the poppet check valve assembly comprising:
a valve housing defining a generally cylindrical valve chamber therethrough with opposing inlet and outlet ports coaxially arranged and distanced from each other along a longitudinal center axis of said valve chamber;
a poppet having a stem portion with a fluid obstruction element at a first end thereof, said poppet slidably arranged inside said valve chamber to transition along said center axis between a seated position, in which said fluid obstruction element is pressed against a seat portion of said valve housing to fluidly seal said inlet port, and an unseated position, in which said obstruction element is distanced from said seat portion thereby allowing fluid to pass from said inlet port to said outlet port, said fluid obstruction element including a plurality of circumferentially oriented fin members protruding outward therefrom to engage with an inner surface of said valve chamber;
a spring member in operative communication with said poppet and configured to bias the same into said seated position; and
a disk member oriented inside said valve chamber and defining a receiving slot configured to receive and mate with a second end of said stem portion
wherein said disk member and said plurality of fin members cooperate to maintain said poppet in coaxial alignment with said longitudinal center axis during said transition between said seated and unseated positions.
